(19) United States
(12) Patent Application Publication
(10) Pub. No.: US 2013/0031417 A1
(43) Pub. Date: Jan. 31, 2013

(54) METHOD AND DEVICE FOR TESTING A PROGRAM STORED IN THE MEMORY OF AN ELECTRIC TOOL

(71) Applicant: Wolfgang Beck, Schongau (DE)

(72) Inventor: Wolfgang Beck, Schongau (DE)

(73) Assignee: Hilti Aktiengesellschaft, Schaan (LI)

(21) Appl. No.: 13/553,291

(22) Filed: Jul. 19, 2012

(30) Foreign Application Priority Data
Jul. 26, 2011 (DE) 10 2011 079 786.6

(51) Int. Cl. G06F 11/36

(52) U.S. Cl. 714/38.1; 714/E11.207

(57) ABSTRACT

A method for testing a program stored in the memory of an electric tool, from a plurality of modules, comprises the following steps: testing the program using at least one predefined safety test while the program is being executed, and testing at least one module from the plurality of modules using at least one predefined module test while the program is being executed.

This claims the benefit of German Patent Application DE 10 2011 079 786.6, filed Jul. 26, 2011 and hereby incorporated by reference herein.

The present invention relates to a method and to a device for testing a program stored in the memory of an electric tool, from a plurality of modules. The memory is, for example, a RAM memory (RAM: Random Access Memory) and the electric tool is, for example, a hand-held power tool, especially an electric hand-held power tool, such as, for instance, an electric screwdriver.

### BACKGROUND

Generally speaking, there are two fundamentally different types of tests for programs or software, namely, module tests and safety tests. The safety tests as well as the module tests are intended to ensure that there are no errors in the program or that any errors that might be present remain without safety-critical consequences. The specifications for the module tests and the safety tests stem from the applicable standards such as, for example, IEC 61508 Part 3 or IEC 60730.

The programs are first tested by means of the module tests before they are released. A program normally consists of a plurality of modules, program modules or program components that can communicate with each other via defined interfaces. The module test, component test or unit test is the software test of these modules or program components. The objective of the module test is to detect program errors in the modules of the programs at an early point in time. The functionality of the modules can often be tested more easily than is the case when the modules have already been combined in the program, since in this case, the dependence of the individual modules would also have to be taken into account.

After the integration of the individual modules into the program and the release of the program, the safety tests pertaining to the execution time of the software are carried out.

However, it is possible that errors in a module of the program only show up while the program is being executed on the electric tool and that these errors cannot be detected by means of the safety tests.

### SUMMARY OF THE INVENTION

It is an object of the present invention to provide a method for testing a program stored in the memory of an electric tool, from a plurality of modules comprises the following steps: testing the program by means of at least one predefined safety test while the program is being executed, and testing at least one module from the plurality of modules by means of at least one predefined module test while the program is being executed.

The present invention provides a method to detect those errors that only occur while the program is being executed on the electric tool but that can only be detected by a module test and not by a safety test. Subsequently, the electric tool can be switched to a safe state. Consequently, according to the invention, more tests, especially module tests, are carried out while the program is being executed on the electric tool. This increases the safety of the electric tool.

Moreover, the work time and the costs invested for setting up the module tests are utilized another time while the program is being executed. As a result, the level of system safety achieved is increased while the invested work and costs remain the same.

The program is a sequential program, a software program or software that is especially used to control the electric tool. The module in question can also be referred to as a predefined program component of the program. The module test, component test or unit test is the software test of the module or program component in question. The module test also comprises the testing of one or more functions of the module in question.

An example of a module of a program for the electric tool can be a PID controller module. Here, the module function of the PID controller module is called by means of the applicable module test with known control deviations, and the module test checks the correctness of the expected controller response. According to the invention, this test is also carried out while the program is being executed on the electric tool.

The expression “while the program is being executed” means while the program is being executed on the electric tool. This also includes the start of the program execution on the electric tool.

In one embodiment, a plurality of predefined module tests is provided, whereby in each case, one module test from the plurality of predefined module tests is predefined for testing one module from the plurality of modules.

In another embodiment, each module from the plurality of modules is tested by means of the associated module test while the program is being executed.

In another embodiment, for each module test, fixed input quantities are entered into the module and the output quantities that result after the fixed input quantities have been entered are ascertained, and the ascertained output quantities are compared to target output quantities in order to provide a module test result. The fixed input quantities can also be referred to as predefined input quantities. Moreover, the target output quantities can also be referred to as predefined output quantities.

In another embodiment, if a specific module test result is present, one specific safety measure is selected from a plurality of predefined safety measures and carried out.

The plurality of predefined safety measures comprises, for example, de-energizing the electric tool, switching the electric tool to a predefined safe state, and safely shutting down the control unit of the electric tool.

In another embodiment, at least one hardware component of the electric tool is tested by means of the at least one safety test while the program is being executed.

Examples of such hardware components are RAM memories, ROM memories, flash drives, multiplexers, clock sources or watchdog devices.

Moreover, a computer program product is being proposed that, on a program-controlled device, initiates the execution of a method as explained above for testing a program stored in the memory of an electric tool.

A computer program product like a computer program means can be provided or delivered, for example, as a memory medium, such as a memory card, a USB stick, a floppy disk, a CD-ROM, a DVD or else in the form of a downloadable file from a server in a network. This can be done, for instance, in a wireless communication network by transmitting the appertaining file containing the computer program product or the computer program means.

Furthermore, a testing device for testing a program that is stored in the memory of an electric tool, from a plurality of modules is being proposed. The testing device has a first testing means and a second testing means. The first testing means is configured to test the program by means of at least one predefined safety test while the program is being executed. The second testing means is configured to test at least one module from the plurality of modules by means of at least one predefined module test while the program is being executed.

In one embodiment, a memory device for storing a plurality of predefined module tests is provided, whereby in each case, one module test from the plurality of predefined module tests is predefined for testing one module from the plurality of the modules.

In another embodiment, the second testing means is configured to test each module from the plurality of modules by means of the associated module test while the program is being executed.

In another embodiment, the second testing means is configured to enter fixed input quantities into the module in question within the scope of each associated module test, to ascertain the resulting output quantities after the fixed input quantities have been entered, and to compare the ascertained output quantities to target output quantities in order to provide a module test result.

In another embodiment, a safety means is provided that is configured in such a way that, if a specific module test result is present, it selects one specific safety measure from a plurality of predefined safety measures and carries it out.

The specific means, the first testing means, the second testing means and the safety means can be implemented in the form of hardware or else software. In the case of a hardware implementation, the specific means can be configured as a device or as part of a device, for instance, as a computer or microprocessor. In the case of a software implementation, the means in question can be configured as a computer program product, as a function, as a routine, as part of a program code or as an executable object.

Furthermore, a control device for controlling an electric tool is being proposed that has a testing device as described above for testing a program stored in the memory of the electric tool, from a plurality of modules.

Moreover, an electric tool is being proposed with a testing device as described above for testing a program stored in the memory of an electric tool, from a plurality of modules.

The electric tool is, for example, a hand-held power tool or an accumulator for a hand-held power tool. The hand-held power tool is especially an electric hand-held power tool such as, for example, an electric screwdriver.

The electric screwdriver has a housing with a handle by means of which a user can hold and guide the electric screwdriver. A pushbutton on the handle allows the user to start up the electric screwdriver. For example, the user has to continuously depress the push-button in order to keep the electric screwdriver in operation.

The electric screwdriver has a tool socket into which the user can insert a screwdriver bit. When the push-button is actuated, an electric motor rotates the tool socket around its axis. The electric motor is coupled to the tool socket via a spindle and optionally via additional components of a drive train such as, for example, a clutch or gears.

### BRIEF DESCRIPTION OF THE DRAWINGS

The description below explains the invention on the basis of embodiments and figures shown by way of an example. The figures show the following:

FIG. 1 a schematic flow diagram of a first embodiment of a method for testing a program stored in the memory of an electric tool,

FIG. 2 a schematic flow diagram of a second embodiment of a method for testing a program stored in the memory of an electric tool,

FIG. 3 a schematic block diagram of a first embodiment of a testing device for testing a program stored in the memory of an electric tool,

FIG. 4 a schematic block diagram of a second embodiment of a testing device for testing a program stored in the memory of an electric tool,

FIG. 5 a schematic block diagram of an embodiment of a control unit of an electric tool, and

FIG. 6 a schematic block diagram of an embodiment of an electric tool.

Unless otherwise indicated, identical elements or elements having the same function are designated in the figures with the same reference numerals.

### DETAILED DESCRIPTION

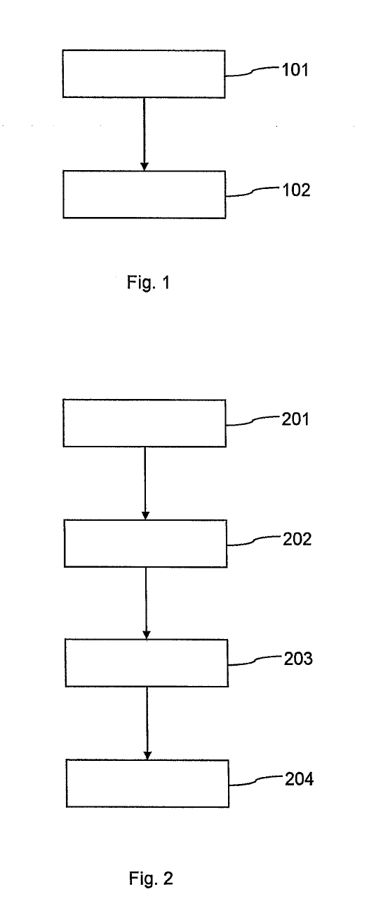

FIG. 1 shows a schematic flow diagram of a first embodiment of a method for testing a program P stored in the memory 2 of an electric tool 3.

The program P consists of a plurality of modules M1-M4. The modules M1-M4 can also be referred to as program modules or program components that can communicate with each other via interfaces.

In Step 101, program P is tested by means of at least one predefined safety test ST while the program P is being executed on the electric tool 3.

In Step 102, at least one module M1-M4 from the plurality of modules M1-M4 is tested while the program P is being executed on the electric tool 3 by means of at least one predefined module test MT1-MT4.

FIG. 2 shows a schematic flow diagram of a second embodiment of a method for testing a program P stored in the memory 2 of an electric tool 3. The program P has a plurality of modules M1-M4 or program modules.

In Step 201, a plurality of predefined module tests MT1-MT4 is provided. In each case, one module test MT1-MT4 is predefined and suitable for testing one specific module M1-M4 from the plurality of modules.

In Step 202, the program P is tested by means of at least one predefined safety test ST while the program is being executed. In this process, especially at least one hardware component of the electric tool 3 is tested by means of the at least one safety test ST while the program is being executed.

In Step 203, each module M1-M4 from the plurality of modules M1-M4 is tested by means of the associated module test MT1-MT4 while the program is being executed. For example, the module test MT1 is associated with the module Ml. The module test MT2 is associated with the module M2. Correspondingly, module test MT3 is associated with the module M3, and module test MT4 is associated with the module M4.

Fixed input quantities are entered into the module M1-M4 during each module test MT1-MT4. The fixed input quantities result from the module test MT1-MT4 associated with each individual module M1-M4. The output quantities that result after the fixed input quantities have been entered are ascertained. The ascertained output quantities are compared to target output quantities in order to provide a module test result E.

In Step 204, a specific safety measure is carried out if one specific module test result is present. The specific safety measure can be selected from a plurality of predefined safety measures as a function of each individual module test result E.

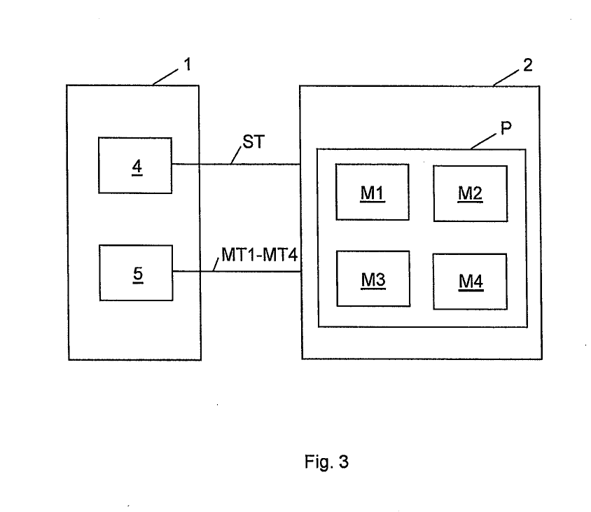

FIG. 3 shows a schematic block diagram of a first embodiment of a testing device 1 for testing a program P stored in the memory 2 of an electric tool 3. The program P comprises at least a plurality of modules M1-M4.

The testing device 1 has a first testing means or tester 4 and a second testing means or tester 5.

The first testing means 4 is configured to test the program P while the program P is being executed on the electric tool 3. For this purpose, the first testing means 4 employs at least one predefined safety test ST.

The second testing means 5 is configured to test at least one module M1-M4 from the plurality of modules M1-M4 while the program P is being executed on the electric tool 3. For this purpose, the second testing means 5 employs at least one predefined module test MT1-MT4.

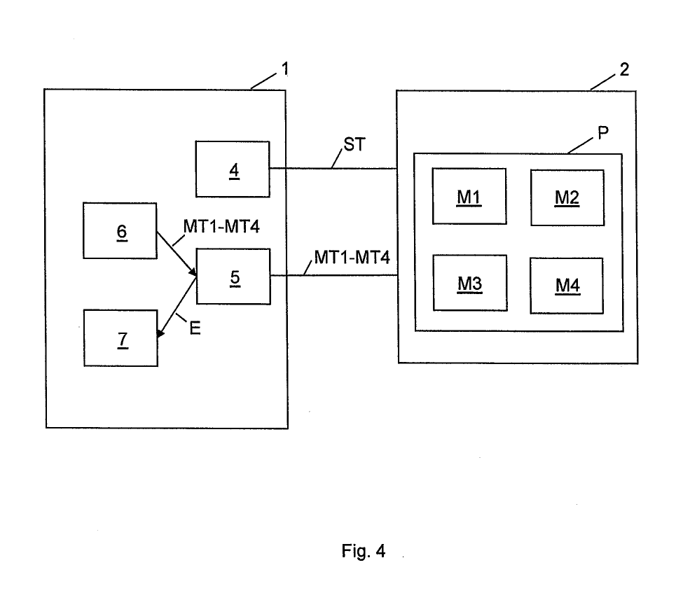

FIG. 4 shows a schematic block diagram of a second embodiment of a testing device 1. The testing device 1 of FIG. 4 comprises all of the features of the testing device 1 of FIG. 3 and moreover, a memory device 6 as well as a safety means 7.

The memory device 6 is configured to store the plurality of predefined module tests MT1-MT4.

The safety means or device 7 is configured so that, if a specific module test result E is present, it selects one specific safety measure from a plurality of predefined safety measures and carries it out. The plurality of predefined safety measures can be stored in the memory device 6.

In particular, the second testing means or tester 5 is configured to test all of the modules M1-M4 by means of the module test MT1-MT4 while the program is being executed. In this process, the second testing means 5 enters fixed input quantities into the appertaining module M1-M4, it ascertains the resultant output quantities after the fixed input quantities have been entered, and it compares the ascertained output quantities to target output quantities in order to provide a module test result E.

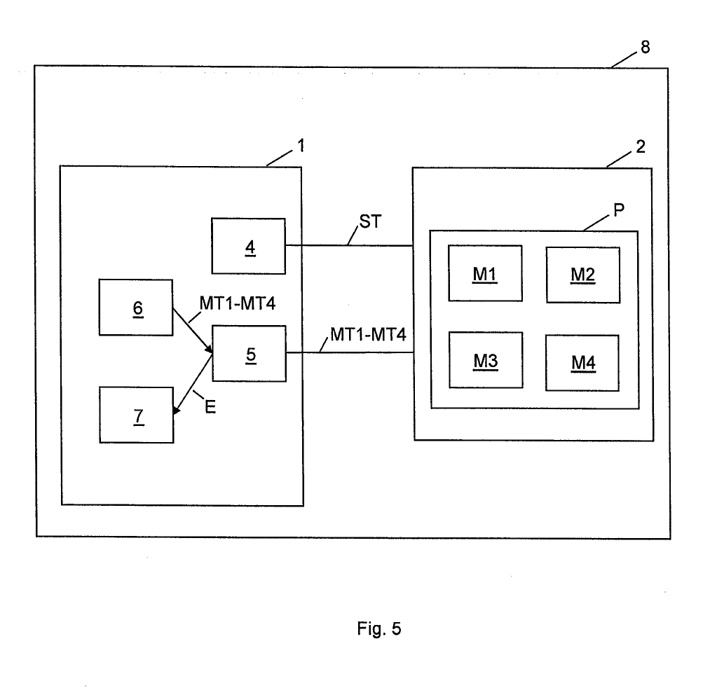

FIG. 5 shows a schematic block diagram of an embodiment of a control unit 8 of an electric tool 3. The control unit 8 has the device 1 according to FIG. 4. As an alternative, the control unit 8 can have the device 1 according to FIG. 3. The control unit 8 is, for example, a microcontroller of the electric tool 3.

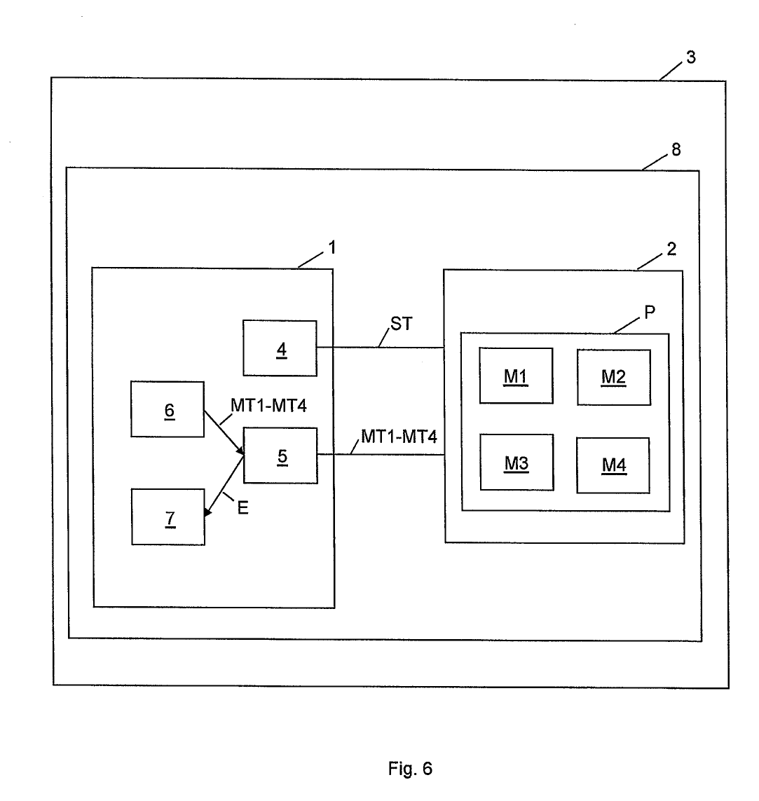

FIG. 6 shows a schematic block diagram of an embodiment of an electric tool 3. The electric tool 3 has the control unit 8 according to FIG. 5. The electric tool 3 is, for example, a hand-held power tool. The electric tool 3 can also be an accumulator for a hand-held power tool.

What is claimed is:

1. A method for testing a program stored in the memory of an electric tool, from a plurality of modules, comprising the following steps:
testing the program using at least one predefined safety test while the program is being executed; and
testing at least one module from the plurality of modules using at least one predefined module test while the program is being executed.

2. The method as recited in claim 1 wherein the at least one predefined module test includes a plurality of predefined module tests, each module test from the plurality of predefined module tests being predefined for testing one module from the plurality of modules.

3. The method as recited in claim 2 wherein each module from the plurality of modules is tested by the associated module test while the program is being executed.

4. The method as recited in claim 2 wherein, for each module test, fixed input quantities are entered into the module and the output quantities that result after the fixed input quantities have been entered are ascertained, and the ascertained output quantities are compared to target output quantities in order to provide a module test result.

5. The method as recited in claim 4 wherein, if a specific module test result is present, one specific safety measure is selected from a plurality of predefined safety measures and carried out.

6. The method as recited in claim 1 wherein at least one hardware component of the electric tool is tested by the at least one safety test while the program is being executed.

7. A testing device for testing a program stored in the memory of an electric tool, from a plurality of modules, comprising:
a first tester configured to test the program using at least one predefined safety test while the program is being executed; and
a second tester configured to test at least one module from the plurality of modules using at least one predefined module test while the program is being executed.

8. The testing device as recited in claim 7 further comprising a memory device for storing a plurality of predefined module tests, whereby in each case, one module test from the plurality of predefined module tests is predefined for testing one module from the plurality of the modules.

9. The testing device as recited in claim 8 wherein the second tester is configured to test each module from the plurality of modules using the associated module test while the program is being executed.

10. The testing device as recited in claim 8 wherein the second tester is configured to enter fixed input quantities into the module in question within the scope of each associated module test, to ascertain the resulting output quantities after the fixed input quantities have been entered, and to compare the ascertained output quantities to target output quantities in order to provide a module test result.

11. The testing device as recited in claim 7 further comprising a safety selector and executor configured in such a way that, if a specific module test result is present, it selects one specific safety measure from a plurality of predefined safety measures and executes the one specific safety measure.

12. A control device for controlling an electric tool comprising a testing device as recited in claim 7.

13. An electric tool comprising a testing device as recited in claim 7.

14. The electric tool as recited in claim 13 wherein the electric tool is a hand-held power tool or an accumulator for a hand-held power tool.
